(19) United States
(12) Patent Application Publication
(10) Pub. No.: US 2020/0378569 A1
(43) Pub. Date: Dec. 3, 2020

(54) BATTERY POWER AUXILIARY DEVICE SYSTEM POWERED BY REMOTELY-CONTROLLED STREETLAMP

(71) Applicant: Memoreyes, LLC, Atlanta, GA (US)

(72) Inventor: John K. Collings, III, Mableton, GA (US)

(21) Appl. No.: 16/884,827

(22) Filed: May 27, 2020

Related U.S. Application Data
(60) Provisional application No. 62/853,493, filed on May 28, 2019.

(51) Int. Cl. F21S 8/08; F21V 23/00; H02J 7/04; H02J 7/00; H05B 47/10; F21S 9/02; H02J 9/06; H04N 7/18

(52) U.S. Cl. CPC F21S 8/086; F21V 23/001; H02J 7/04; H02J 7/0042; F21W 2131/103; F21S 9/02; H02J 9/061; H04N 7/183; H05B 47/10

(57) ABSTRACT

A lighting and auxiliary system includes a streetlamp that is powered intermittently by a locally-switched common power source via a power wire from the locally-switched common power source. An auxiliary device is mounted on the streetlamp. A device wire is electrically coupled to the power wire. A battery is mounted on the streetlamp and is configured to provide power to the auxiliary device. A charging circuit receives power from the device wire and charges the battery during periods when power is available from the locally-switched common power source. The battery provides power to the auxiliary device during periods when power from the locally-switched common power source is turned off.

### CROSS-REFERENCE TO RELATED APPLICATION(S)

This application claims the benefit of U.S. Provisional Patent Application Ser. No. 62/853,493, filed May 28, 2019, the entirety of which is hereby incorporated herein by reference.

### BACKGROUND OF THE INVENTION

### 1. Field of the Invention

The present invention relates to power systems for streetlamp accessories and, more specifically, to a battery powering system.

### 2. Description of the Related Art

Some streetlamps, such as streetlamps on public thoroughfares are controlled by local photo-active switches. Such streetlamps turn on when it is dark enough to cause the photo-active switch to turn “on” and shut off when it is light enough to cause the photo-active switch to turn “off” Such streetlamps always have power supplied to the photo-active switch, which is usually located near the lighting element itself.

Powering an installed accessory, such as a surveillance camera that is mounted on the pole of the streetlamp, is relatively easy: one simply taps a lead from the power input to the photo-active switch and feeds it to the accessory.

However, streetlamps in many parking lots can be powered from a common remotely-controllable power source. Such systems improve service delivery time while reducing electric power consumption for the lighting service by controlling the lighting so as it is on only when needed. The locally switched common power source can turn all such streetlamps “on” and “off” simultaneously. With such systems, no power is delivered to the pole when the common power source is turned “off” As a result, there is no power available from the streetlamp to power any installed accessories. As a result, alternative power must be supplied to the accessories when the power source has been turned off. This can be complicated and expensive, especially when trying to retrofit accessories to previously-installed streetlamps.

Some lighting poles use photoelectric sensors to perform this function but that presumes the lighting service is needed all the time the sun is down. This invention does not apply to these situations.

Therefore, there is a need for an inexpensive and simple system for powering streetlamp accessories mounted on commonly-supplied streetlamps when the common power source is turned “off.”

### SUMMARY OF THE INVENTION

In one aspect, the invention is a lighting and auxiliary system that includes a streetlamp that is powered intermittently by a locally-switched common power source via a power wire from the locally-switched common power source. An auxiliary device is mounted on the streetlamp. A device wire is electrically coupled to the power wire. A battery is mounted on the streetlamp and is configured to provide power to the auxiliary device. A charging circuit receives power from the device wire and charges the battery during periods when power is available from the locally-switched common power source. The battery provides power to the auxiliary device during periods when power from the locally-switched common power source is turned off.

In another aspect, the invention is a system associated with a streetlamp that is powered by a locally switched power source via a power wire from the power source. A security device is mounted on the streetlamp. A battery is mounted on the streetlamp and is configured to provide power to the security device. The battery is charged with power from a device wire that is electrically coupled to the power wire. The battery provides power to the security device when the locally switched power source is turned off. A charging circuit receives power from the device wire when the locally switched power source is turned on and charges the battery.

In yet another aspect, the invention is a method of providing power to a streetlamp-mounted auxiliary device, wherein the streetlamp receives power through a power wire that is electrically coupled to a locally-switched common power source. A streetlamp-mounted battery is charged with power from the locally-switched common power source through a device wire that is electrically coupled to the power wire during periods when the locally-switched common power source is switched on. The streetlamp-mounted auxiliary device is powered with power from the streetlamp-mounted battery so that the streetlamp-mounted auxiliary device runs during periods when the locally-switched common power source is switched off.

### BRIEF DESCRIPTION OF THE FIGURES OF THE DRAWINGS

FIG. 1 is a schematic drawing of one embodiment of a battery power system.

FIG. 2 is a schematic drawing of a detail of the power supply system.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. The present disclosure should in no way be limited to the exemplary implementations and techniques illustrated in the drawings and described below. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

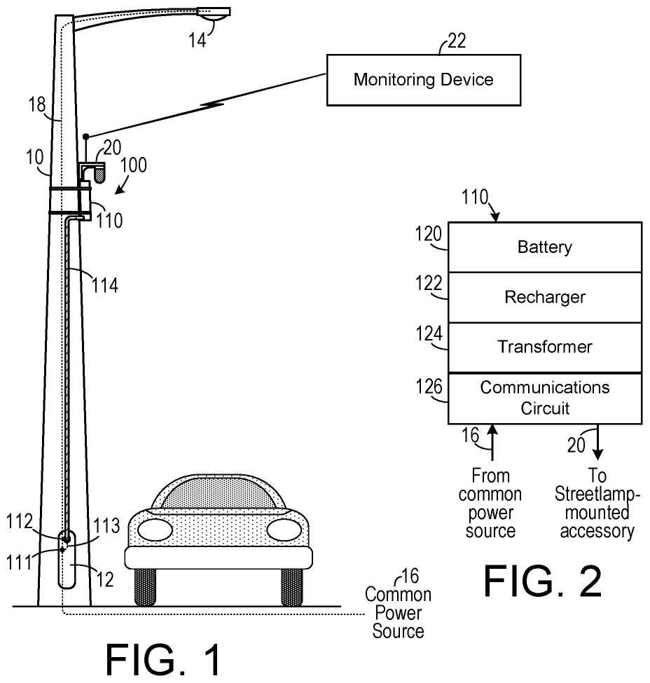

As shown in FIGS. 1 and 2, one embodiment of a battery power system 110 for powering an accessory 20 (such as a surveillance camera, or the like) that is mounted on the pole 10 of a streetlamp 14. A power wire 18 runs through the pole to power the streetlamp 14. Power is supplied from a common power source 16, such as from a breaker connected to a power grid. The streetlamp 14 is of the type used to illuminate a parking lot and is typically turned off during by opening a breaker inside of a building to which the parking lot is appended. The lighting for such parking lots is typically turned off during certain periods determined by the building manager. For example, the streetlamps for a store parking lot are often turned off a certain time after the store closes. (For example, when a store closes at midnight, the streetlamps can be turned off at 1:00 AM and turned on again at dust of the following evening.)

The battery power system 110 includes a conduit 114 through which a device wire 113 runs that taps power from the streetlamp power wiring at a node 111 inside the streetlamp that is accessed through a hole 112 in the access cover 12. The battery power system 110 receives power from the streetlamp power wiring when the locally switched common power source 16 is supplying power to the streetlamp 14. During this time, the system 110 charges a battery 120 that supplies power to the accessory 20 when the common power source 16 is “off.”

The battery power system 110, as shown in greater detail in FIG. 2, includes a battery 120 (such as a lithium ion battery, or the like) that is charged by a recharger 122 that receives power from the common power source 16 through a transformer 124. The transformer can be a multi-voltage transformer that transforms the several different common streetlamp-supply voltages (e.g., 120V, 220V, 208V, 277V and 480V AC in one embodiment) to a voltage commonly used by the battery recharger 122 (e.g., 24V DC). The transformer 124 can also include a unit that transforms the battery voltage to a different voltage required by the accessory 20, if necessary. A wireless communication circuit 126 for communicating with a monitoring device 22 can be included with the battery power system 110.

When the power to the light pole is turned on, the system operates the camera electronics and charges the battery. When the light pole power is turned off, the camera electronics is powered from the charged battery. Additionally, the light pole itself tends to be in the right place for the cameras.

The present system provides power to streetlamp auxiliary systems during predictable periods when the centrally supplied power to the streetlamp is turned off (unlike a battery backup that only serves upon unscheduled interruption of primary continuous service). It has the advantage of not requiring alternate power sources, such as solar panels.

The power supply electronics have a limited distance purpose like short range radio (micro cell) or video surveillance cameras but need constant power. This use coincides with the existing permanently placed structure (the power pole) which also has scheduled but not permanent power. Intermittently powered existing lighting poles were not designed, nor intended as a deployment platform for limited distance electronics service such as micro cells and surveillance cameras yet when combined with this power supply they can be re-tasked as such without additional cabling or construction. The combination of these features and functions results in the useful outcome of a now useable platform without erecting a new structure or pulling wires for permanent power or communications.

Although specific advantages have been enumerated above, various embodiments may include some, none, or all of the enumerated advantages. Other technical advantages may become readily apparent to one of ordinary skill in the art after review of the following figures and description. It is understood that, although exemplary embodiments are illustrated in the figures and described below, the principles of the present disclosure may be implemented using any number of techniques, whether currently known or not. Modifications, additions, or omissions may be made to the systems, apparatuses, and methods described herein without departing from the scope of the invention. The components of the systems and apparatuses may be integrated or separated. The operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. It is intended that the claims and claim elements recited below do not invoke 35 U.S.C. § 112(f) unless the words “means for” or “step for” are explicitly used in the particular claim. The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A lighting and auxiliary system, comprising:
(a) a streetlamp that is powered intermittently by a locally-switched common power source via a power wire from the locally-switched common power source;
(b) an auxiliary device that is mounted on the streetlamp;
(c) a device wire electrically coupled to the power wire;
(d) a battery mounted on the streetlamp and configured to provide power to the auxiliary device; and
(e) a charging circuit that receives power from the device wire and that charges the battery during periods when power is available from the locally-switched common power source,
wherein the battery provides power to the auxiliary device during periods when power from the locally-switched common power source is turned off.

2. The lighting and auxiliary system of claim 1, wherein the streetlamp includes a pole through which the power wire runs internally and wherein the pole includes an access port for accessing the power wire.

3. The lighting and auxiliary system of claim 2, further comprising a conduit mounted external to the pole and through which the device wire runs, the conduit in communication with the access port and extending to the charging circuit.

4. The lighting and auxiliary system of claim 1, wherein the auxiliary device comprises a security system.

5. The lighting and auxiliary system of claim 4, wherein the security system comprises a camera.

6. The lighting and auxiliary system of claim 4, wherein the security system comprises a transmission circuit that relays data from the security system to a remote monitoring device.

7. A system associated with a streetlamp that is powered by a locally switched power source via a power wire from the power source, comprising:
(a) a security device that is mounted on the streetlamp;
(b) a battery mounted on the streetlamp and configured to provide power to the security device and that is charged with power from a device wire that is electrically coupled to the power wire, wherein the battery provides power to the security device when the locally switched power source is turned off; and
(c) a charging circuit that receives power from the device wire when the locally switched power source is turned on and that charges the battery.

8. The system of claim 7, wherein the streetlamp includes a pole through which the power wire runs internally and wherein the pole includes an access port for accessing the power wire.

9. The system of claim 8, further comprising a conduit mounted external to the pole and through which the device wire runs, the conduit in communication with the access port and extending to the charging circuit.

10. The system of claim 7, wherein the security device comprises a camera.

11. The system of claim 7, wherein the security device comprises a transmission circuit that relays data from the security system to a remote monitoring device.

12. A method of providing power to a streetlamp-mounted auxiliary device, wherein the streetlamp receives power through a power wire that is electrically coupled to a locally-switched common power source, comprising the steps of:
(a) charging a streetlamp-mounted battery with power from the locally-switched common power source through a device wire that is electrically coupled to the power wire during periods when the locally-switched common power source is switched on; and
(b) powering the streetlamp-mounted auxiliary device with power from the streetlamp-mounted battery so that the streetlamp-mounted auxiliary device runs during periods when the locally-switched common power source is switched off.

13. The method of claim 12, wherein the streetlamp is mounted on a pole through which the power wire runs internally thereto and further comprising the step of running the device wire through a conduit that is mounted externally to the pole and that is in communication with an access port at the base of the pole.

14. The method of claim 12, wherein the streetlamp-mounted auxiliary device comprises a security device and a wireless communication circuit and further comprising the step of transmitting data from the security device to a remote device.

15. The method of claim 14, wherein the security device comprises a camera.
